(19) United States
(12) Patent Application Publication
(10) Pub. No.: US 2025/0353661 A1
(43) Pub. Date: Nov. 20, 2025

(54) SPRAY WAND DISPENSER AND RUST PROTECTOR APPLICATION SYSTEM

(71) Applicant: B'LASTER LLC, Valley View, OH (US)

(72) Inventors: Theodore Bradley, North Ridgeville, OH (US); Gregory L Skillicorn, Akron, OH (US)

(73) Assignee: B'LASTER LLC, Valley View, OH (US)

(21) Appl. No.: 19/206,959

(22) Filed: May 13, 2025

Related U.S. Application Data
(60) Provisional application No. 63/647,435, filed on May 14, 2024.
(60) Provisional application No. 63/715,234, filed on Nov. 1, 2024.

(51) Int. Cl. B65D 83/14; B65D 83/141

(52) U.S. Cl. CPC B65D 83/7532; B65D 83/141

(57) ABSTRACT

Dispenser [20] and system [100] providing a surface treatment to metal parts, equipment and vehicles for corrosion prevention. The dispenser [20] has an external housing [22] with an actuator [40], a valve for engaging a valve stem [V] of a canister, a button trigger [28] for activation, and a trigger return spring, to bias the button trigger [28] out of engagement with the valve. An outlet [26] from the external housing [22] enables removable attachment of a reusable flexible elongate delivery conduit [60] having a support wire [62]. Delivery conduit is stored wrapped around the external housing, and extends for between at least 2 and 3 feet for use. A fluid delivery end [68] of the delivery conduit includes a delivery nozzle [80] enabling a user to provide a spray pattern for fluid delivery, where the spray pattern dispenses fluid at a 45° angle with respect to the delivery conduit.

### CROSS-REFERENCE TO RELATED APPLICATIONS

The present application claims the priority benefit to U.S. Provisional Patent Application Nos. 63/647,435 filed May 14, 2024 and 63/715,234 filed Nov. 1, 2024, the entireties of which are incorporated herein by reference.

### FIELD OF INVENTION

The present disclosure relates to a dispensing apparatus or dispenser and a spray wand system for application, for example, of a rust and corrosion protection surface treatment.

### BACKGROUND OF THE INVENTION

Equipment and vehicles stored and/or used outdoors are unavoidably subject to weather conditions such as rain, snow and exposure to moisture from fields, grass or water during use. Metal materials used in such equipment and vehicles are particularly vulnerable to rust and corrosion due to their exposure to such moisture. The application of surface treatment chemicals to metal surfaces of moving parts, equipment and vehicles can assist with prevention of rust and corrosion.

To treat metal surfaces for rust and corrosion protection, chemical surface treatments are often provided as sprays from pressurized aerosol canisters containing the chemical surface treatment materials. Prior art canisters have the disadvantage of being limited in the distance the spray can be provided to a surface from the canister. Where the metal surfaces and moving parts of a vehicle undercarriage are being treated, for example, the limited range reached when spraying treatment materials directly from a canister can be awkward and has numerous disadvantages. Extension straws for spraying a longer distance are often used by press fitting one end of the extension straw into an outlet from the canister spray nozzle, but such straws typically only provide an increase of about a 4 to 6 inch extension. Additionally, such straws provide a more pointed or directed spray, instead of a wider fan-type spray pattern. While a wider spray pattern is desired for more quickly treating some larger metal surfaces with chemical surface treatments over larger area, smaller more direct applications are also desired. There is a need for an improved dispenser for application of chemical surface treatments.

### SUMMARY OF THE INVENTION

This application provides a dispenser and a system for application of a chemical surface treatment to metal surfaces of moving parts, equipment and vehicles. The dispenser includes an external housing with a storage location for a removable delivery conduit and having an outlet for fluid connection with and guidance of the delivery conduit during operation. The external housing also contains actuator components forming a connection to a pressurized canister containing the chemical surface treatment, and for enabling release of the chemical from the canister via the outlet. The external housing has a base for snap-on attachment to the top of the pressurized canister over a valve stem enabling fluid flow from the canister upon activation by a user of a button trigger of the actuator components. The actuator components include the outlet configured for removable engagement with the delivery conduit, preferably by external threads on an exterior surface of the outlet.

A surface extending radially outward from the base of the external housing provides a shelf or base shelf for supporting the delivery conduit, and a circular wall extending upward from the shelf, each of which enable the delivery conduit to be wrapped around or encircle the external housing for storage. A top shelf may optionally also be provided spaced from and above the shelf at the base of the external housing. The top shelf extends radially outward from a portion of the top of the circular wall and enables additional confinement of the delivery conduit during storage, but does not interfere with operation of the actuator components. The flexible delivery conduit is provided with an elongate wire guide, provided either within a central passage within the delivery conduit, or embedded within a portion of a wall of the delivery conduit. The delivery conduit is wrapped and constrained for storage between the base shelf and top shelf a number of times, and for a 2 to 3 foot long delivery conduit, for example, it typically wraps at least 4 to 5 wraps around the circular wall.

The dispenser may further include a cap or overcap for use during shipment and storage, for engaging and covering the external housing and delivery conduit. The delivery conduit has a fluid receiving end engaged within a hose attachment for attachment to the outlet from the actuator components of the external housing. In the preferred embodiment, the hose attachment is permanently secured to the delivery conduit, and includes internal threads, for example, for secure mating engagement with the outlet and for receiving fluid from the canister via the actuator components.

A fluid delivery end of the delivery conduit may support a delivery nozzle permanently secured to the delivery conduit. The delivery nozzle may be a polymer or metal nozzle configured with an internal central passage enabling delivery of fluid from out of the nozzle engaged on the delivery conduit. Removal of the hose attachment of the delivery conduit from the outlet of the actuator components in the external housing enables a user to select an alternative spray pattern option-one using the delivery nozzle on the delivery conduit, and a second using a fan spray pattern provided directly from the outlet. In an alternate embodiment, the fluid delivery end of the removable and reusable delivery conduit supports a spray nozzle tip with multiple fluid spray pattern delivery, including a side spray pattern when in a side spray position. The spray nozzle tip may be either fixed or axially slidable, and enable delivery of fluid at a 90° angle, or a forward directed 45° angle with respect to, and from, several side ports formed through the spray nozzle tip at locations surrounding the delivery nozzle. The side spray pattern enables fully coating the inside of a tube, for example.

In another embodiment, a locking rotary attachment is provided on the fluid receiving end engaged within an alternate hose attachment for locking engagement with the dispenser housing adjacent the outlet, for enabling selection of a fan spray pattern. To remove the locking rotary attachment, a quarter turn locking and unlocking engagement is provided using locking tabs located on the button trigger dispenser housing for mating engagement with the locking rotary attachment, to form an interference fit when fully tightened in locking position.

The system includes a pressurized canister for holding the fluid. The canister has an interior reservoir, and an outlet port in fluid communication with the interior reservoir. The delivery ends of the dispenser delivery conduits are in fluid communication with the outlet port and outlet of the dispenser external housing. Alternate configurations for the outlet from the external housing may also be provided.

### BRIEF DESCRIPTION OF THE DRAWINGS

Embodiments will now be described, by way of example only, with references to the accompanying drawings in which:

FIG. 1 is a partial schematic perspective view of a dispenser covered by a cap containing the delivery conduit removed from the external housing, all in a storage position on a canister containing the fluid for chemical surface treatment.

FIG. 2 is a partial schematic perspective view of the dispenser of FIG. 1 with the cap removed prior to unwinding of the delivery conduit.

FIG. 3 is a partial schematic perspective side view of the dispenser of FIG. 1.

FIG. 4 is a partial schematic perspective side view of the dispenser, detached delivery conduit with elongate wire guide, hose attachment and nozzle, with the canister of the system of FIG. 1.

FIG. 5 is a partial cut-away side view of the dispenser, delivery conduit and canister of the system shown in FIG. 4.

FIG. 6 is a partial schematic perspective view of the dispenser, delivery conduit and canister of the system shown in FIG. 4, but with the hose attachment on the delivery conduit engaged with the outlet on the button trigger.

FIG. 7 is a front schematic view of the dispenser and canister of the system.

FIG. 8 is a side schematic view of the system of FIG. 7, showing the delivery conduit removed from the dispenser.

FIG. 9 is a rear schematic view of the system of FIG. 7.

FIG. 10 is a front schematic view of the dispenser and canister of the system.

FIG. 10A is a partial cut-away side view of the dispenser and canister taken along the line A-A of FIG. 10.

FIG. 10B is an enlarged view of the section indicated in FIG. 10A, and showing the removable attachment of the delivery conduit to the outlet via mating threaded engagement.

FIG. 11 is an exploded and enlarged view of an alternate embodiment of the system on a canister showing a dispenser housing button trigger, nozzle insert and removable delivery conduit with elongate wire guide for attachment via a locking rotary attachment.

FIG. 12 is a cut-away exploded and enlarged view of the embodiment of FIG. 11.

FIG. 13 is an enlarged view of the embodiment of FIG. 11, showing the locking rotary attachment with the delivery conduit prior to engagement with the dispenser housing button trigger.

FIG. 14 is an enlarged view of the embodiment of FIGS. 11 and 13, showing the locking rotary attachment with the attached delivery conduit engaged with the dispenser housing prior to locking rotation of the locking rotary attachment in the direction of the arrow, to engage mating locking tabs on the locking rotary attachment with locking tabs on the dispenser housing button trigger.

FIG. 15 is a cut-away enlarged view of the embodiment of FIG. 14 following locking rotation of the locking rotary attachment with the mating locking tabs on the locking rotary attachment engaged with locking tabs on the dispenser housing button trigger, and with the external housing of the dispenser positioned over the button trigger and locking rotary attachment in position for storage of the delivery conduit by wrapping around the external housing.

FIG. 16 is a cut-away enlarged view of the locking rotary attachment and delivery conduit engaged with the dispenser housing button trigger, and showing one possible attachment of the elongate wire guide within the delivery conduit to the locking rotary attachment.

FIG. 17 is a further enlarged cut-away view of the interference fit provided following locking rotation, typically a quarter turn rotation, and engagement of the mating locking tabs on the locking rotary attachment and dispenser housing button trigger.

FIG. 18 is an enlarged translucent view of an alternate embodiment of a spray nozzle tip with a side spray pattern, which side spray pattern is shown in the off position.

FIG. 19 is a view of the spray nozzle tip of FIG. 18 shown in the open side spray pattern position.

FIG. 20 is a cut-away view of the spray nozzle tip of FIG. 19.

FIG. 21 is a partial perspective view of an alternate embodiment of a dispenser covered by a cap containing the delivery conduit removed from the external housing, all in a storage position on a canister containing the fluid for chemical surface treatment.

FIG. 22 is a partial schematic perspective view of the dispenser of FIG. 21 with the cap removed and the delivery conduit secured to the external housing.

FIG. 23 is a partial schematic side view of the dispenser of FIG. 22.

FIG. 24 is a partial top schematic top view of the dispenser of FIG. 22.

FIG. 25 is an enlarged, partial, schematic, cut-away, side view of the dispenser of FIG. 23 with the spray nozzle tip and wire guide positioned within the internal central passage of the delivery conduit with bent ends to avoid interference with operation and for ensuring the wire guide is retained within the delivery conduit.

FIG. 26 is an exploded schematic perspective view of the dispenser external housing and delivery conduit of FIG. 23.

### DETAILED DESCRIPTION OF THE EMBODIMENTS

While the subject matter of this application may be embodied in many different forms, described here are a preferred embodiment as well as alternate embodiments, with the understanding that the present disclosure is to be considered as an exemplification of the principles described and is not intended to limit the broad aspects described to the embodiments illustrated. It will be understood that the disclosure may be embodied in other specific forms without departing from the spirit or central characteristics thereof. For context, the orientation of the components may be referred to by directions (e.g., top, bottom, right, left, etc.) as shown in the figures, or with a prime designation where similar features in an alternate form are provided. Those skilled in the art will recognize that during use these directions may be changed without changing the relationship between components. The present embodiment, therefore, is to be considered in all respects as illustrative and not restrictive, and not to be limited to the details given herein.

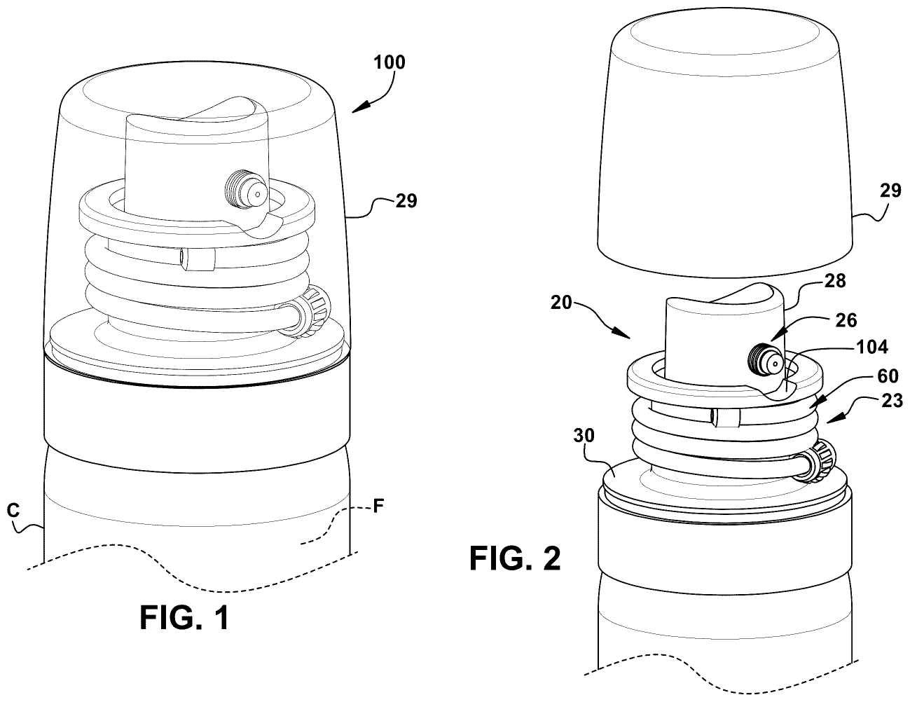

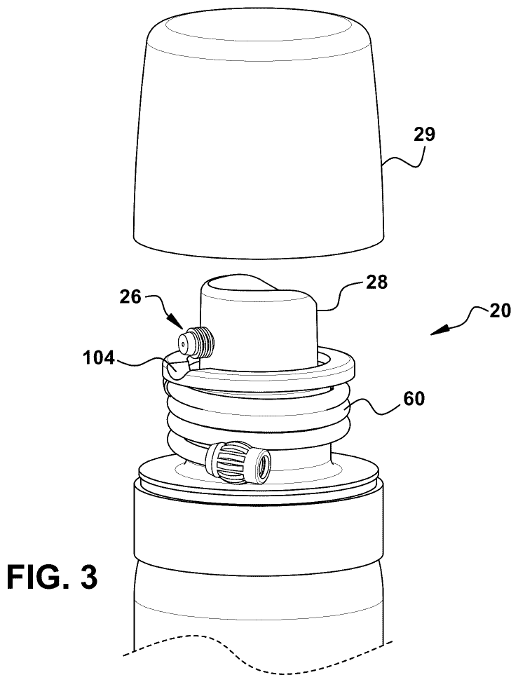

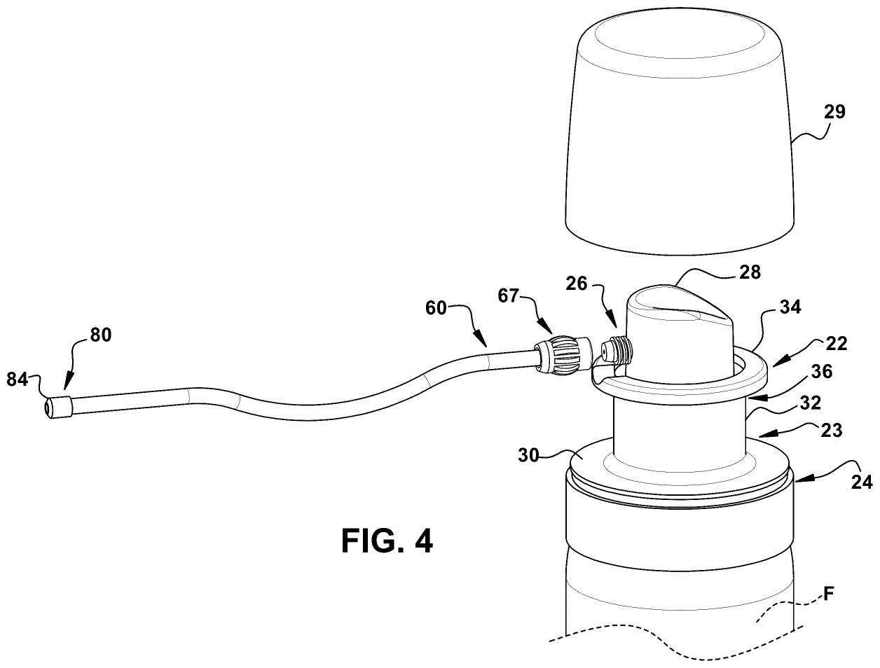

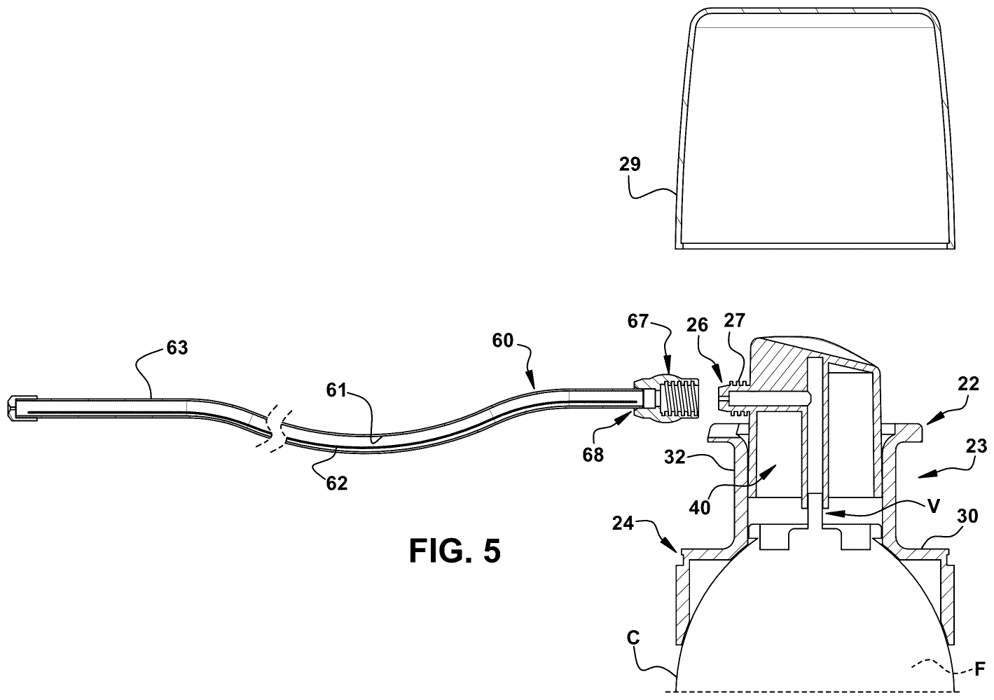

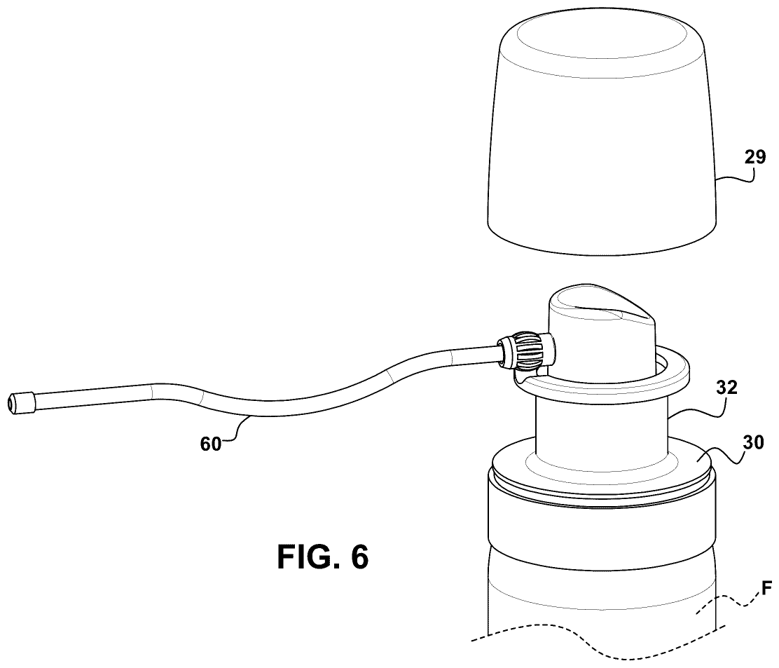

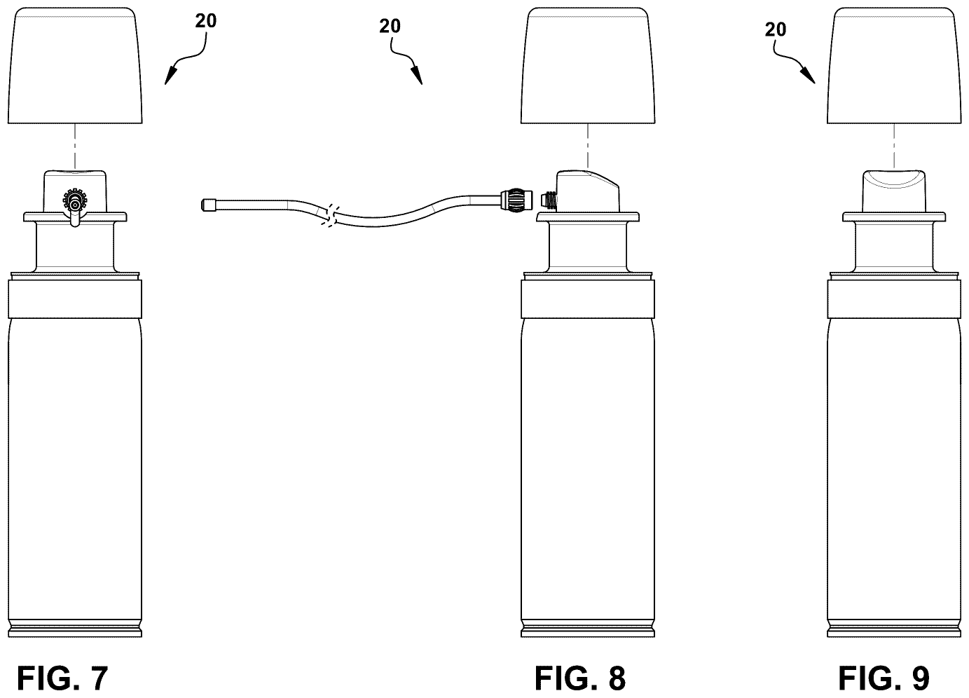

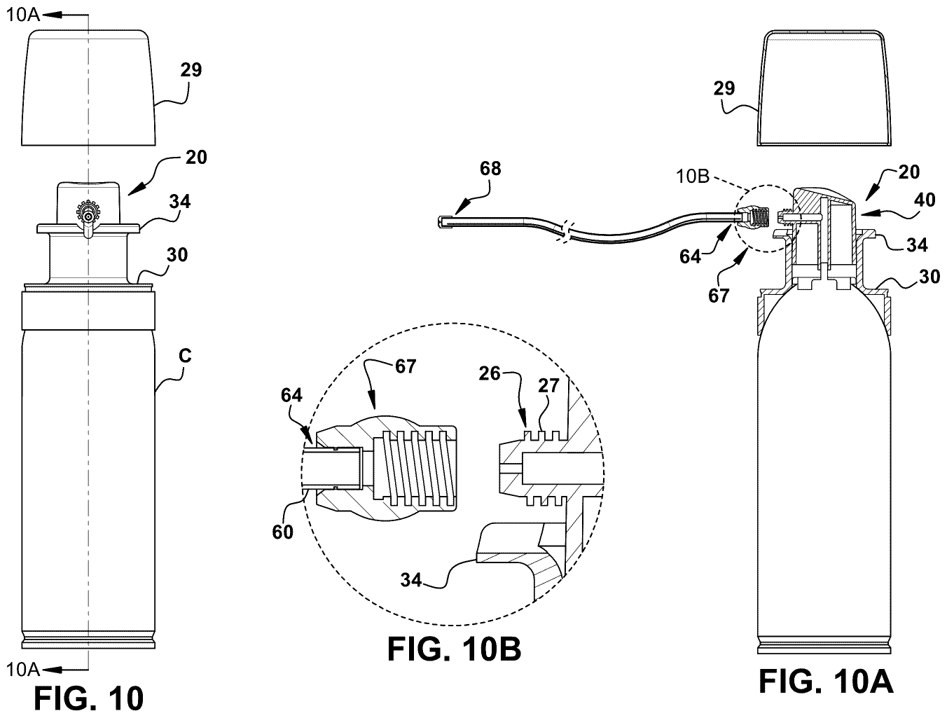

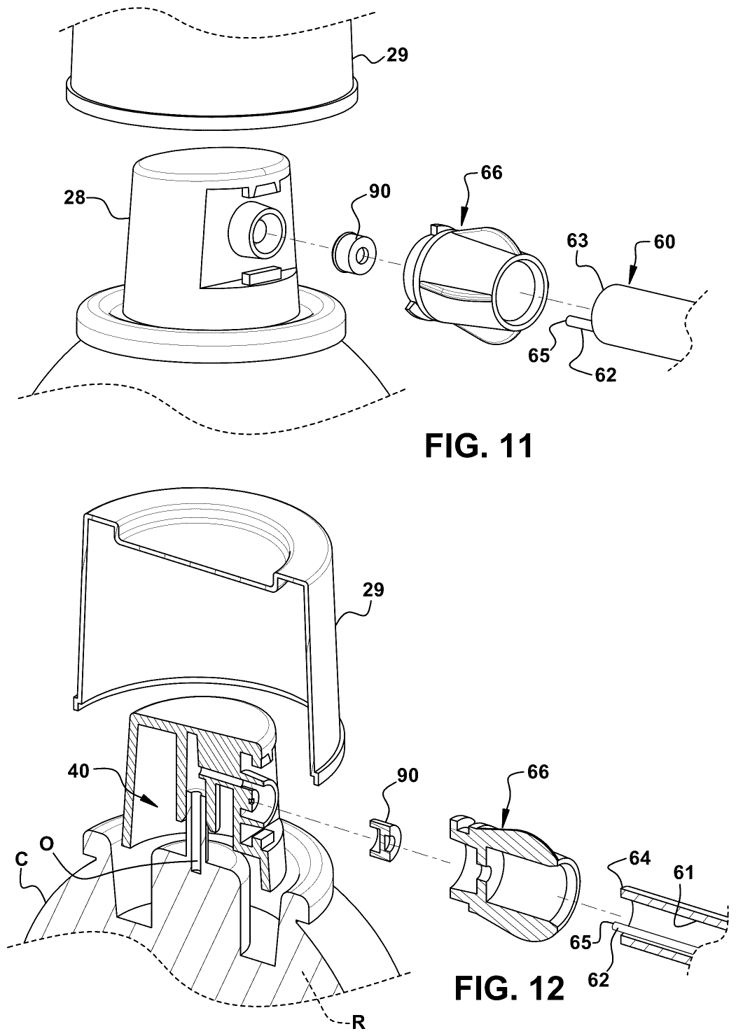

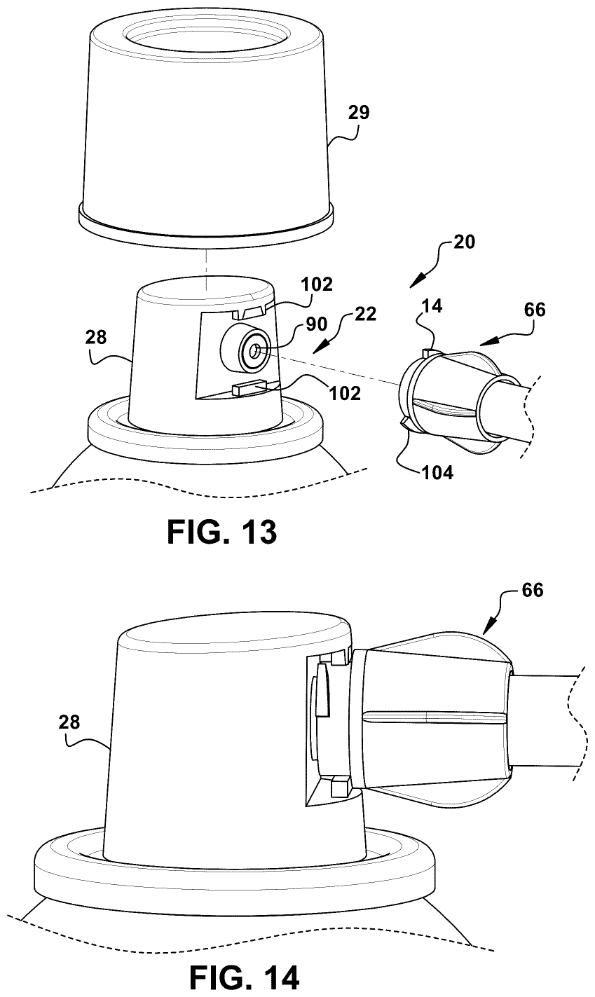

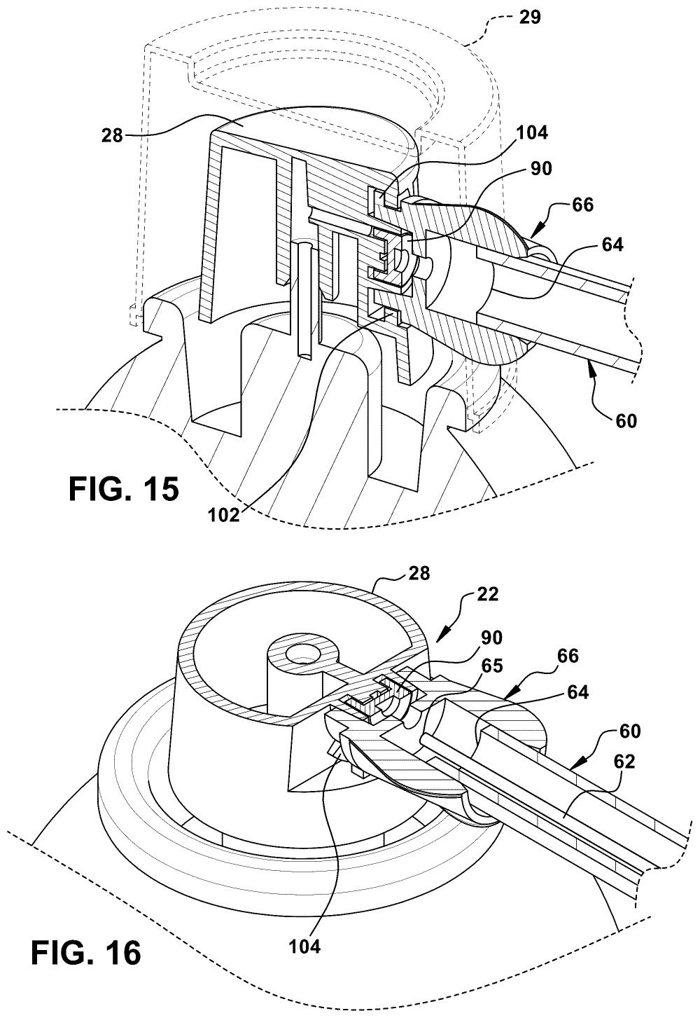

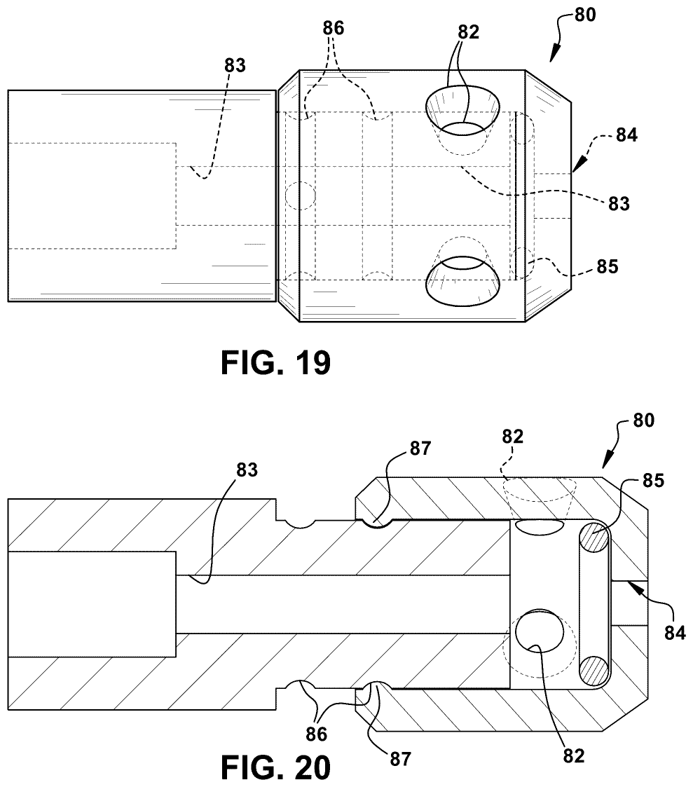

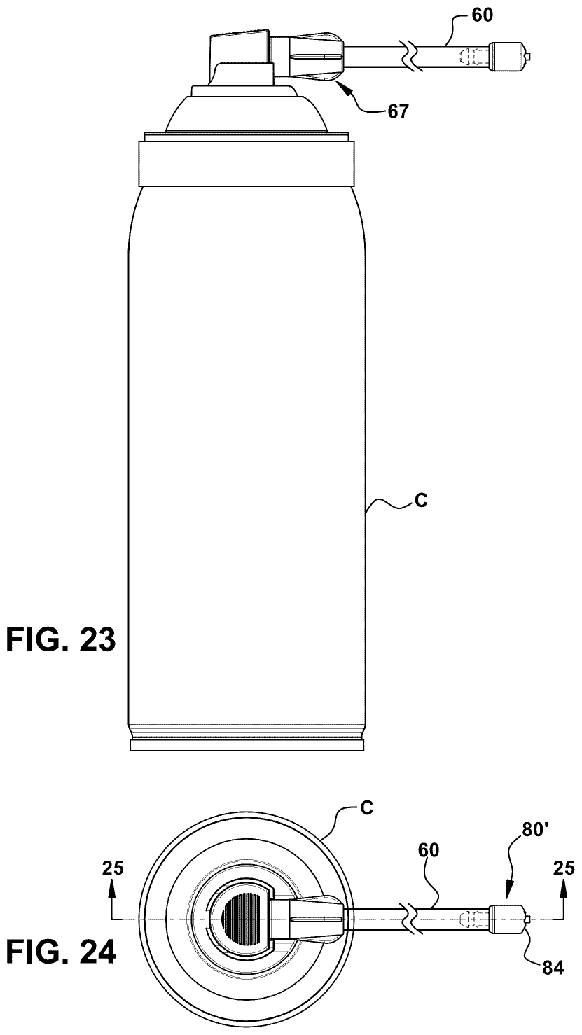

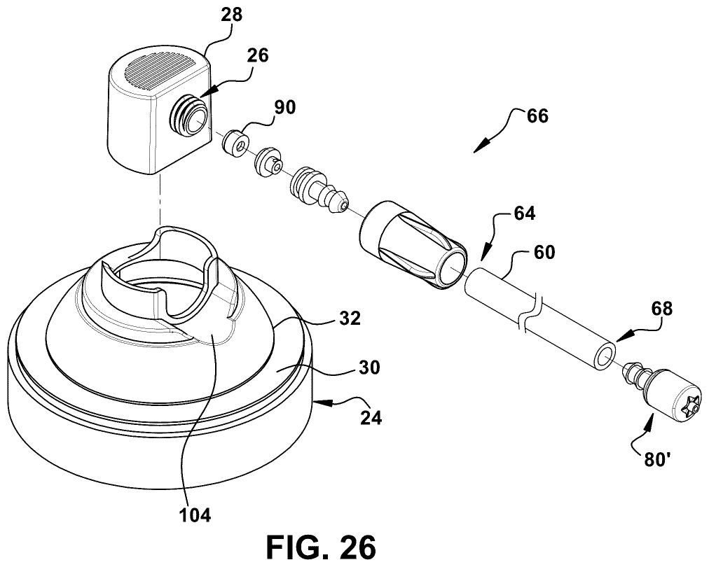

The dispenser 20 and system 100 for application of a chemical surface treatment is shown in an embodiment in FIGS. 1 to 10B, and in other embodiments in FIGS. 11 to 20 and FIGS. 21 to 26. The dispenser 20 includes the external housing 22 with a storage location 23 for a removable delivery conduit 60, and having an outlet 26 for fluid connection with and guidance of the delivery conduit during operation. The external housing 20 also contains actuator components 40 forming a connection to a pressurized canister C containing the chemical surface treatment F, and for enabling release of the chemical F from the canister via the outlet 26. The external housing 20 has a base 24 for snap-on attachment to the top of the pressurized canister C over a valve stem V enabling fluid F flow from the canister upon activation of the actuator components 40. The actuator components 40 include the outlet 26 configured for removable engagement with the delivery conduit 60, preferably, when shown in the embodiment of FIGS. 1 to 10, by external threads 27 on an exterior surface of the outlet 26.

A surface extending radially outward from the base of the external housing provides a shelf or base shelf 30 for supporting the delivery conduit 60, and a circular wall 32 extending upward from the shelf 30, which together enable the delivery conduit to be wrapped around or encircle the external housing 22 for storage. The circular wall 32 has an outer diameter of between 1.5 and 3.5 inches, and preferably approximately about 2.5 inches for engagement with and surrounded by the delivery conduit 60 during storage. A top shelf 34 may optionally also be provided spaced from and above the base shelf 30 of the external housing, preferably approximately 1.5 inches above the base shelf. The top shelf 34 extends radially outward from a portion of the top 36 of the circular wall 32 and enables additional confinement of the delivery conduit 60 during storage, but does not interfere with operation of the actuator components 40. The delivery conduit 60 is wrapped and constrained for storage on the base shelf, and optionally between the top shelf 34, a number of times. For a 2 to 3 foot long delivery conduit 60, for example, it typically wraps at least 4 to 5 wraps around the circular wall 32.

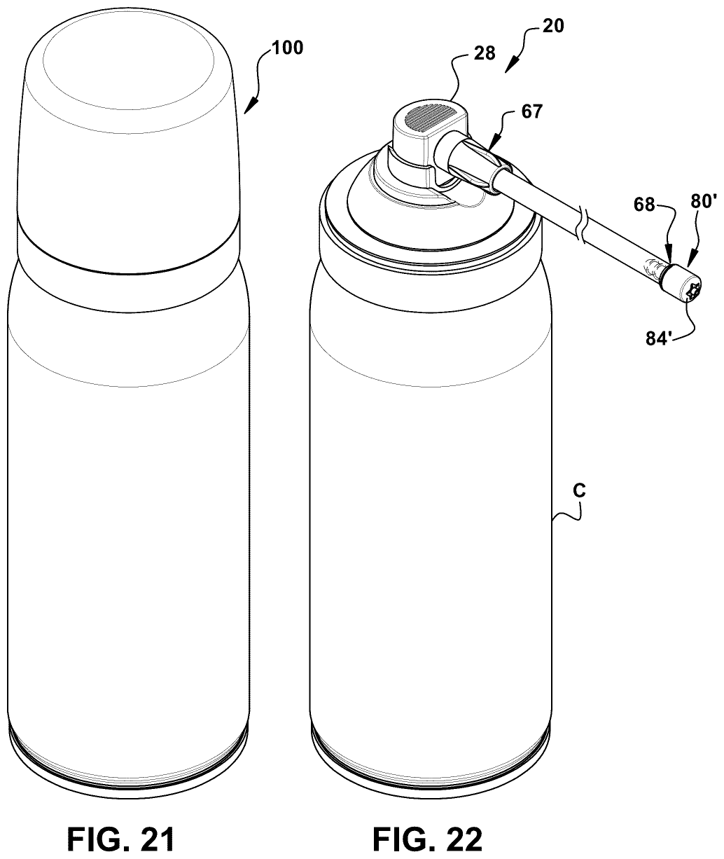

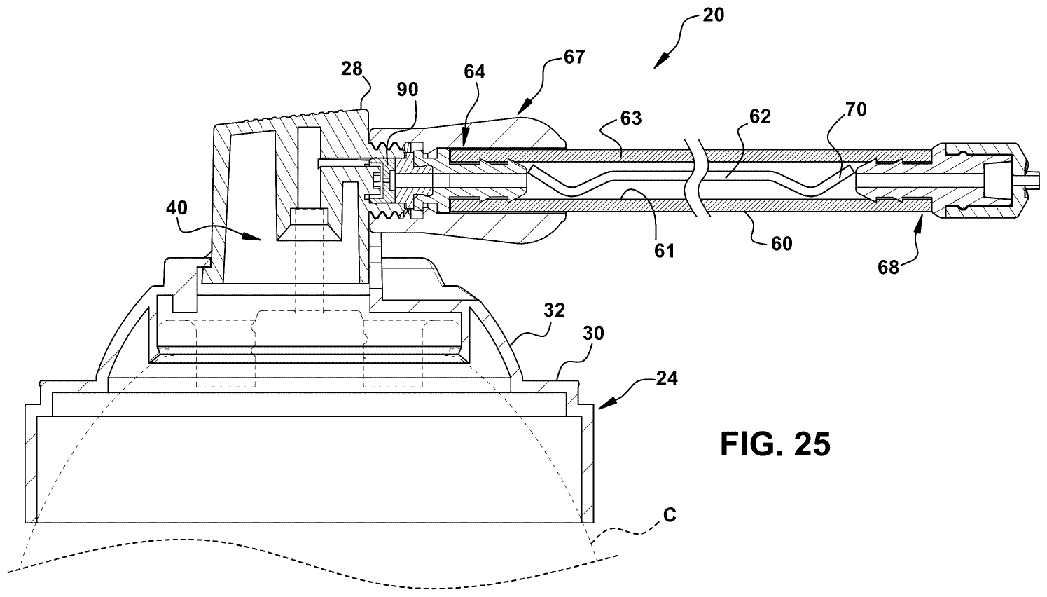

The delivery conduit 60 is a flexible conduit preferably between 18 inches and 3 feet long, more preferably between 2 and 3 feet long, and most preferably approximately 2 to 2.5 feet in length. The flexible delivery conduit 60 is provided with an elongate wire guide 62, provided either threaded within an elongate internal central passage 61 within the delivery conduit, or embedded within a portion of a wall 63 of the delivery conduit. Manufacture of the delivery conduit 60 with the embedded wire guide 62 is typically accomplished during extrusion of the delivery conduit. The delivery conduit 60 has an internal diameter of approximately 0.125 inches, and is preferably manufactured of a polyethylene plastic or other suitable flexible polymer material. In either embodiment, the wire guide 62 may be along the entire length of the delivery conduit, or along portions of the length of the delivery conduit. While the embedded wire guide 62 is preferably provided along the entire length of the delivery conduit 60, alternatives such as a shorter length (perhaps along the central length of the delivery conduit, but leaving a gap at each end) or a number of shorter spaced lengths of the wire guide, may be a sufficient alternative. In one embodiment shown in FIGS. 11 to 16, the embedded wire guide 62 extends outwardly from a fluid receiving end 64 of the delivery conduit adjacent the dispenser external housing 22, such that an end 65 of the wire guide 62 may be staked, tied, pressed, spot welded, glued or otherwise secured to a locking rotary attachment 66 engaged with the fluid receiving end 64 of the delivery conduit. Another embodiment is provided in FIGS. 21 to 26. In the enlarged cut-away embodiment of FIG. 25, the delivery conduit includes an alternate spray nozzle tip 84, and the wire guide 62′ is positioned within an internal central passage 61 with bent ends to avoid interference with operation and for ensuring the wire guide 62′ is retained within the delivery conduit. In any preferred embodiment, the delivery conduit 60 is configured to enable storage surrounding or wrapping around the external housing and for desired positioning of the elongate delivery conduit during operation of the system 100.

The dispenser may further include a snap on cap or overcap 29 for use during shipment, retail sale and storage, for engaging the canister C and covering the external housing 22 and delivery conduit 60. The fluid receiving end 64 of the delivery conduit 60 may be engaged within an internally threaded hose attachment 67, as in FIGS. 1 to 10 and 21 to 26, for removable attachment to the threads 27 of the outlet 26 of the external housing. Alternatively, the locking rotary attachment 66 of FIGS. 11 to 16 enables removable attachment to the outlet 26. In the illustrated embodiments, the hose attachment 66, 67 may be permanently secured to the fluid receiving end 64 of the delivery conduit 60, and the internal threads or rotary connection in the hose attachments 67, 66, respectively, secure mating engagement with the outlet 26 and for receiving fluid F from the canister C during operation of the actuator components 40. Fluid F is received within the delivery conduit 60 along the elongate central internal passage 61 between the fluid receiving end 64 and a fluid delivery end 68.

Removal of the hose attachment 66, 67 of the delivery conduit from the outlet 26 of the external housing 22 enables a user to select an alternative spray pattern option using a fan spray pattern provided directly from the outlet, as in FIGS. 1 to 3 and FIGS. 11 to 18. Thus, the present construction enables multiple spray pattern options at multiple distances of application.

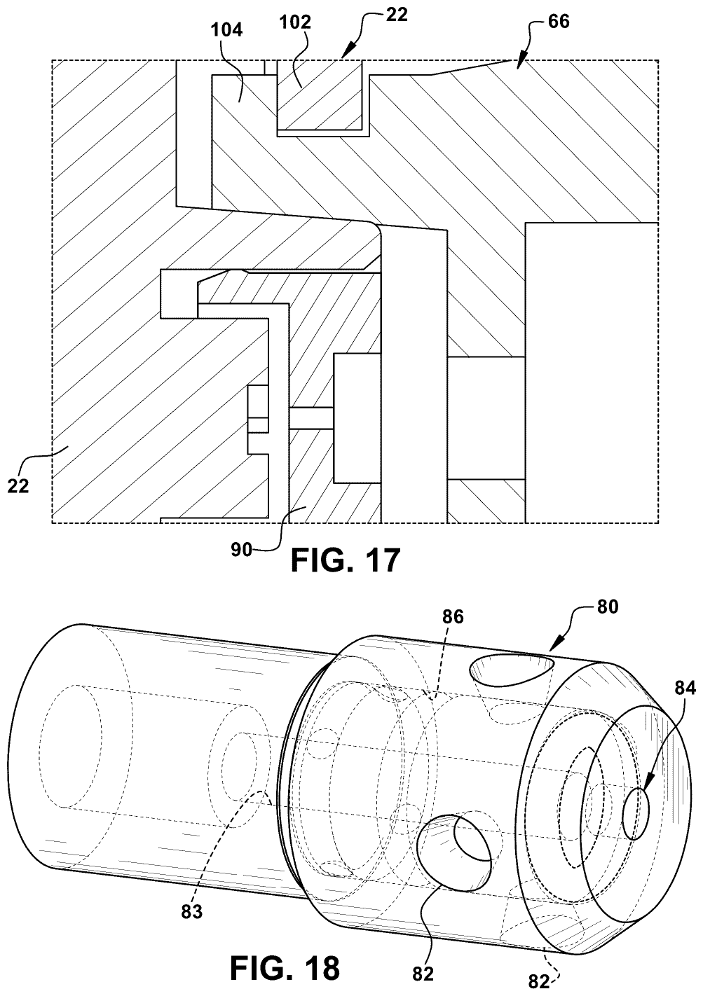

To provide multiple spray pattern options at a longer distance from the canister C via the elongate delivery conduit 60, the fluid delivery end 68 of the delivery conduit 60 may support a delivery nozzle 80 that is preferably permanently secured to the delivery conduit. As shown in FIGS. 17 to 20, the fluid delivery end 68 of the removable and reusable delivery conduit 60 supports a delivery spray nozzle 80 with multiple fluid delivery settings. The spray nozzle is preferably a metal nozzle configured with internal nozzle passages 82, having a conical configuration, enabling delivery of fluid from the delivery nozzle 80 at a transverse angle of approximately a 90° side spray angle, or a forward directed 45° side spray angle with respect to, and from, the delivery conduit 60. Additionally, the delivery nozzle includes a central nozzle passage 83 and spray nozzle tip 84 for a stream pattern of fluid application. FIGS. 17 to 20 illustrate the placement of an O-ring 85 provided between the fluid delivery end 68 of the delivery conduit and the spray nozzle tip 84 to avoid fluid leakage. The configuration of the delivery nozzle 80 uses the internal central nozzle passage 83 for delivery of fluid in a directed spray pattern from the end of the spray nozzle tip 84. Use of this spray pattern enables fluid to be successfully sprayed from at least 2 feet away from the desired target. To direct fluid from the spray nozzle tip 84, the external surface 69 of the fluid delivery end 68 of the delivery conduit 60 has circumferential grooves 86 for seating boss portions or bumps 87, extending from an inner surface of the spray nozzle tip 84, to ensure placement of the delivery nozzle 80 in the desired spray position. When seated in a first circumferential groove 86 located away from the end of the spray nozzle tip 84, the delivery nozzle is in the conical spray position, and fluid is delivered in the conical pattern.

Additionally, the spray nozzle tip 84 has a side-spray pattern when in the side spray position, as in FIG. 18, enabling delivery of fluid at a transverse approximately 90° angle with respect to, and from several locations surrounding, the delivery nozzle 80. To select the side spray pattern, the spray nozzle tip 84 is pulled outward along the central axis of the delivery conduit, such that the bumps 87 engage a second groove 86 located as shown in FIGS. 18 and 20. When engaged within the second groove, fluid is delivered via the internal nozzle passages or side ports 82 and the spray nozzle tip 84. At least two, and potentially three or five side ports are preferably provided in offset locations from the internal central passage. The side ports 82 provide a spray pattern that enables fully coating the inside of a tube. For example, the elongate delivery conduit 60 may be inserted into a tube or pipe in the side-spray position. Activation of the button trigger 28 while withdrawing the delivery conduit 60 from the tube or pipe, sprays fluid from the side ports 82 to coat the inside of the tube or pipe with fluid. A gripping surface or features may be provided on an external surface of the spray nozzle tip to assist with axial and rotational movement of the delivery nozzle 80 between spray positions.

In the embodiment of FIGS. 21 to 26, a fixed delivery nozzle 80′ is provided secured within the internal central passage of the delivery conduit. The delivery nozzle 80′ is provided for dispensing fluid from the internal central passage at a forward directed and transverse angle with respect to the fluid dispensing end of the delivery conduit 60, which is preferably a 45° side spray angle with respect to the internal central passage 83′. Such a spray pattern also enables a wide surface area, as well as coating the inside of a tube or pipe.

A fan spray pattern is also provided for the user upon removal of the locking rotary attachment 66 or hose attachment 67 on the delivery conduit 60 from the actuator components 40, button trigger 28 and external housing 22. Once removed from the dispenser housing, a fan spray pattern is provided from the outlet 26 via a nozzle insert 90 within the button trigger, as in FIGS. 11 to 13. To remove the locking rotary attachment 66, a quarter turn locking and unlocking engagement is provided using locking tabs 102 located on the button trigger 28 of the dispenser housing 22, and mating locking tabs 104 on the locking rotary attachment, to form an interference fit when fully tightened in locking position, as shown in FIGS. 14-17. Removal of the hose attachment 67 is provided by simply rotating the delivery conduit until the hose attachment is unthreaded from the fluid outlet 26.

The actuator components 40 secured within the external housing 22 include a valve 101 or passages for engaging the valve stem V, to engage and receive fluid from the pressurized canister C. Numerous prior art valves and actuator component configurations are well known, and the present configuration may be formed as an independent valve, or configured within an internal portion of the button trigger 28. The valve 101 forms a passage configured with an inlet and the outlet to enable fluid communication of the fluid from the pressurized canister to the external housing outlet 26 and optionally interconnected delivery conduit 60. The valve passage receives flow from the canister upon operation of the button trigger 28 of the dispenser or dispenser housing activated into operating engagement and a valve open position under finger compression by a user on an external surface of the button trigger 28 and an internal trigger return spring (not shown). The external surface of the button trigger includes ribs for ease of operation. The actuator components 40 include the trigger return spring to bias the button trigger out of engagement with the valve to a closed position. The button trigger with the valve passage may be of any suitable shape from any suitable material, such as injection molded rigid plastic or polymer. An outlet depression 104 is provided in the external housing to avoid interference with the outlet and delivery conduit during operation by a user.

The system includes the pressurized canister C for holding the fluid F. The canister has an interior reservoir R, and an outlet port O in fluid communication with the interior reservoir. The fluid receiving end of the delivery conduit is in fluid communication with the outlet 26 from the external housing via the outlet port O of the canister C and connected valve passage, through which the fluid flows from the canister. The fluid delivery end 68 of the delivery conduit 60 is in fluid communication with the outlet 26 of the dispenser external housing 22. Alternate configurations for the outlet from the external housing may also be provided.

A canister of fluid chemical surface treatment is preferably used with the system and is generally between 11 and 18 ounces of fluid housed within the interior reservoir. Larger canisters of fluid may also be provided, with or without a reusable delivery conduit of the type described. When the canister with the removable locking rotary attachment and dispensing conduit is empty, the locking rotary attachment and dispensing conduit may be removed and retained for reuse on another similar canister of fluid, which may have been purchased as a refill and without a delivery conduit.

The dispenser and system being described and further described in the claims, may be varied in many ways. Such variations are not to be regarded as a departure from the spirit and scope set forth herein, and all such modifications as would be obvious to one skilled in the art are intended to be included within the scope of the configurations described.

1. A dispenser [20] for providing a chemical surface treatment, the dispenser comprising,
an external housing [22] having a fluid outlet [26] engaged with a flexible elongate delivery conduit [60], wherein the flexible elongate delivery conduit includes a support wire [62] and is wrapped around a portion [32] of the external housing [22] during storage, and during operation extends for a length of at least approximately 2 feet from the fluid outlet [26], and a fluid delivery end [68] of the flexible elongate delivery conduit includes a delivery nozzle [80] providing a spray pattern for delivering fluid [F].

2. The dispenser [20] for providing a chemical surface treatment of claim 1, wherein the flexible elongate delivery conduit [60] has a length of more than 2 feet from the fluid outlet [26].

3. The dispenser [20] for providing a chemical surface treatment of claim 1, wherein the fluid outlet [26] provides fluid having a first spray pattern and a second spray pattern.

4. The dispenser [20] for providing a chemical surface treatment of claim 2, wherein one spray pattern of fluid provided from the delivery nozzle [80] dispenses fluid at a transverse approximately 90° angle of spray with respect to the flexible elongate delivery conduit [60].

5. The dispenser [20] for providing a chemical surface treatment of claim 2, wherein one spray pattern of fluid provided from the delivery nozzle [80] dispenses fluid at a forward directed spray pattern at a transverse approximately 45° angle with respect to the flexible elongate delivery [60].

6. The dispenser [20] for providing a chemical surface treatment of claim 1, wherein the flexible elongate delivery conduit [60] is removable from the external housing fluid outlet [26] for reuse.

7. The dispenser [20] for providing a chemical surface treatment of claim 2, wherein the delivery nozzle [80] dispenses fluid at a transverse angle of spray through at least 2 side ports [82] formed through the delivery nozzle [80] in communication with an internal central passage [81] of the delivery nozzle [80] and fluid delivery [68] end of the flexible elongate delivery conduit [60].

8. A spray wand system [100] for dispensing a fluid treatment from a dispenser [20], the dispenser having a removable, reusable, flexible elongate delivery conduit [60], attachable to and extending from a fluid outlet [26] from the dispenser [20] for at least approximately 2 feet, and having a wire guide [62] extending within the flexible elongate delivery conduit [60], either within a central passage [61] within the delivery conduit, or embedded within a portion of a wall [63] of the delivery conduit [60].

9. The spray wand system [100] for dispensing a fluid treatment from a dispenser of claim 8, wherein the removable, reusable, flexible elongate delivery conduit [60] supports a removable rotary attachment [67] secured at a fluid receiving end [64] of the flexible elongate delivery conduit [60].

10. The spray wand system [100] for dispensing a fluid treatment from a dispenser of claim 9, wherein the fluid outlet [26] from the dispenser [20] includes a locking outlet [102] for mating engagement with the removable rotary attachment [66] of the flexible elongate delivery conduit [60] for removably attaching the flexible elongate delivery conduit [60] to the dispenser [20].

11. The spray wand system [100] for dispensing a fluid treatment from a dispenser of claim 8, wherein the wire guide [62] extending within the flexible elongate delivery conduit [60] within the central passage [61] includes bent ends 65] spaced from ends of the central passage for avoiding interference with the dispensing of fluid treatment from the dispenser [22], and retaining the wire guide [62] within the central passage [61] of the flexible elongate delivery conduit [60].

12. The spray wand system [100] for dispensing a fluid treatment from a dispenser of claim 8, wherein one spray pattern of fluid provided from the removable, reusable, flexible elongate delivery conduit [60] dispenses fluid at a transverse approximately 90° angle of spray with respect to the removable, reusable, flexible elongate delivery conduit [60].

13. The spray wand system [100] for dispensing a fluid treatment from a dispenser of claim 8, wherein one spray pattern of fluid provided from the removable, reusable, flexible elongate delivery conduit [60] dispenses fluid at a forward directed spray pattern at a transverse approximately 45° angle with respect to the removable, reusable, flexible elongate delivery conduit [60].

14. A method for providing a chemical surface treatment comprising the steps of:
unwrapping a flexible elongate delivery conduit [60] having a support wire [62] from a storage position wrapped around a portion [32] of a dispenser external housing [22],
attaching a rotary attachment [66, 67] on a fluid receiving end [64] of the flexible elongate delivery conduit [60] to a fluid outlet [26] on the dispenser external housing [22] to provide fluid communication of the chemical surface treatment from a first connected canister [C] to a fluid dispensing end [69] of the flexible elongate delivery conduit;
extending the flexible elongate delivery conduit [60] for a length of at least approximately 2 feet from the fluid outlet [26],
dispensing the chemical surface treatment from the connected canister [C] via the spray nozzle [80] on the fluid delivery end of the flexible elongate delivery conduit [60];
removing the flexible elongate delivery conduit [60] from the fluid outlet [26] following application of the chemical surface treatment [F] from the connected canister [C]; and
attaching the rotary attachment [66, 67] on the fluid receiving end [64] of the flexible elongate delivery conduit [60] to reuse the flexible elongate delivery conduit on a fluid outlet [26] on a dispenser external housing [22] providing fluid communication of a chemical surface treatment [F] from a second connected canister [C].

15. The method for providing a chemical surface treatment of claim 14, further comprising the step of:
storing the flexible elongate delivery conduit [60] on the second connected canister [C] by wrapping the flexible elongate deliver conduit [60] around a portion [32] of the dispenser external housing [22] of the second connected canister.

16. The method for providing a chemical surface treatment of claim 14, further comprising the step of:
dispensing the chemical surface treatment [F] using a spray nozzle [80] positioned on a fluid delivery end [68] of the flexible elongate delivery conduit [60] providing a spray pattern of fluid via side ports, with the spray pattern having a forward directed transverse approximately 45° angle of spray with respect to the spray nozzle [80] and flexible elongate delivery conduit [60].

17. The method for providing a chemical surface treatment of claim 14, further comprising the step of:
selecting a desired spray pattern prior to dispensing the chemical surface treatment using a spray nozzle [80] movably positioned on a fluid delivery end [68] of the flexible elongate delivery conduit [60].
